(19) United States
(12) Patent Application Publication
(10) Pub. No.: US 2012/0174905 A1
(43) Pub. Date: Jul. 12, 2012

(54) Ground level portable saw machine

(76) Inventor: Wy Peron Lee, Riverside, CA (US)

(21) Appl. No.: 12/930,617

(22) Filed: Jan. 11, 2011

(51) Int. Cl. B28D 1/04; E21C 25/16

(52) U.S. Cl. 125/12

(57) ABSTRACT

A portable saw machine includes a supporting frame, a cutting blade provided at a lower front side of the supporting frame for cutting the object at the ground level, a power device supported by the supporting frame for driving the cutting blade to rotate, and a power cutting arrangement. The power cutting arrangement includes a blade supporting frame movably extended from the supporting frame to suspendedly and adjustably support the cutting blade in a substantially horizontal orientation; and an actuating unit adapted to manually actuated to drive the blade supporting frame to adjust an elevation of the cutting blade so that when the cutting blade is driven to rotate by the power device, the cutting blade is arranged to cut the object at the ground level along the predetermined path without requiring a user to pivotally lift up the main frame.

### BACKGROUND OF THE PRESENT INVENTION

1. Field of Invention

The present invention relates to a saw machine, and more particularly to a ground level portable saw machine comprising a power cutting arrangement which allows a cutting blade to cut object at ground level along a predetermined path without requiring the user to partially or pivotally lift up the entire saw machine.

2. Description of Related Arts

A conventional saw machine for cutting concrete at ground level usually comprises a supporting frame having a pair of rear wheels and a pair of front wheels rotatably provided at a rear and a front portion of the supporting frame respectively, a power device comprising a heavy duty motor supported by the supporting frame, a cutter guard supported at a front side of the supporting frame, a cutting blade rotatably mounted within the cutter guard, and a handle frame extended from the supporting frame for allowing a user of the saw machine to push the supporting frame to move forward for cutting a predetermined object, such as concrete, at ground level.

There are several disadvantages in association of this sort of traditional saw machine. First and foremost, the traditional saw machine requires the user to manually grab the handle frame and exert a frontward moving force to the supporting frame in order to push the cutting blade to move forward. As one skilled in the art might have conceived, this physical action demands substantial stamina on the part of the user.

In fact, when one is actually cutting objects at ground level using this traditional saw machine, the user has to pivotally lift up the entire saw machine about the rear wheel so that the user is able to push the supporting frame and the cutting blade to move frontwardly for cutting that object along a predetermined path. The rear wheels serve to rotatably support the supporting frame and the power device so that a user is able to push the supporting frame and the cutting blade forwardly more easily. Having said that, the user has still to apply a substantial force for pushing the entire saw machine frontwardly along a predetermined path so as to accomplish the goal of cutting the object at ground level.

Second, since the saw machine has to be operated by pivotally and inclinedly lift up about the rear wheels, there exist other mechanical problems as a result of this mode operation. For example, when the saw machine is pivotally lift up so that it forms an inclination to the ground, the engine oil lucubrating the power device will also be tilted at one side corresponding to the angle of inclination. The consequence of this is that when the engine oil is not evenly distributed for lubricating the power device when it is operating, the power device is easy to have problems and may even fail or have overheat problem in the long run. Moreover, for traditional saw machine, the major factor in controlling the depth of the cut is the inclination of the saw machine, which depends on the skill of the operator.

Third, when the traditional saw machine is operating, the user has to push the machine to move forwardly in order to cut the object at ground level. Usually, there is a predetermined cutting path so that the user can control the shape of the resulting work piece. In practice, however, controlling the saw machine to move along that particular path presents substantial difficulty. In part, this is because the saw machine is very heavy and has poor agility. Furthermore, since the saw machine is only supported by the rear wheels when it is pivotally lift up to perform the cutting operation, the stability of the cutting operation may not be good enough to accomplish high quality cutting (e.g. resulting in sharp cutting edge and having accurate cutting shape).

Fourth, almost all conventional saw machine does not include any convenient or effective arrangements for removing the residuals of the objects during the cutting process. As a matter of fact, the residuals may interfere with the cutting process or affect of the quality of the resulting cut.

### SUMMARY OF THE PRESENT INVENTION

A main object of the present invention is to provide a ground level portable saw machine comprising a power cutting arrangement which allows a cutting blade to cut object at ground level along a predetermined path without requiring the user to partially or pivotally lift up the entire saw machine. In other words, the main components, which are the heaviest part of the saw machine, are stationary supported during operation.

Another object of the present invention is to provide a ground level portable saw machine comprising a power cutting arrangement, which allows a user of the present invention to easily and conveniently adjust the depth of the cut without needing to physically lift up or down the entire saw machine. In other words, the user is able to conveniently actuate the power cutting arrangement for adjusting the height of the cutting blade.

Another object of the present invention is to provide a ground level portable saw machine comprising a power cutting arrangement, wherein when the saw machine is perform a cutting operation, it is stably yet movably supported by supporting wheels so that the cutting blade is always align with the center line of the saw machine in order to maximize the quality and efficiency of the cutting operation. In other words, the ground level portable saw machine is a walk behind saw machine for the user to push the saw machine from behind, so as to enable the user to align the cutting blade with the cutting path.

Another object of the present invention is to provide a ground level portable saw machine comprising a power cutting arrangement, wherein the ground level portable saw machine is capable of being folded into a relatively compact structure for easy storage or transportation.

Another object of the present invention is to provide a ground level portable saw machine comprising a power cutting arrangement having a blade guard protecting the blade, wherein the blade guard and the blade is always positioned to be substantially horizontal so as to ensure the cutting quality of the present invention.

Accordingly, in order to accomplish the above object, the present invention provides a portable saw machine for cutting object at ground level along a predetermined path, comprising:

a supporting frame which comprises a main frame and at least a pair of rear wheels provided on a rear side of the main frame;

a cutting blade provided at a lower front side of the supporting frame for cutting the object at the ground level;

a power device supported by the supporting frame for driving the cutting blade to rotate; and

a power cutting arrangement, which comprises:

a blade supporting frame movably extended from the main frame to suspendedly and adjustably support the cutting blade in a substantially horizontal orientation; and an actuating unit operatively supported by the main frame to connect with the blade supporting frame, wherein the actuating unit is adapted to manually actuated to drive the blade supporting frame to adjust an elevation of the cutting blade so that when the cutting blade is driven to rotate by the power device, the cutting blade is arranged to cut the object at the ground level along the predetermined path without requiring a user to pivotally lift up the main frame.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a ground level power saw machine according to a preferred embodiment of the present invention.

FIG. 2 is a perspective view of a ground level power saw machine according to a preferred embodiment of the present invention, illustrating a rear side of the ground level power saw machine.

FIG. 3 is a side view of the ground level power saw machine at the folded position according to the above preferred embodiment of the present invention.

FIG. 4A and FIG. 4B are schematic diagrams of the ground level power saw machine according to the above preferred embodiment of the present invention.

FIG. 5 is a schematic diagram of the ground level power saw machine according to the above preferred embodiment of the present invention, illustrating one side of the ground level power saw machine.

FIG. 6 illustrates the ground level power saw machine incorporating with the vacuum arrangement according to the above preferred embodiment of the present invention.

### DETAILED DESCRIPTION OF THE PREFERRED EMBODIMENT

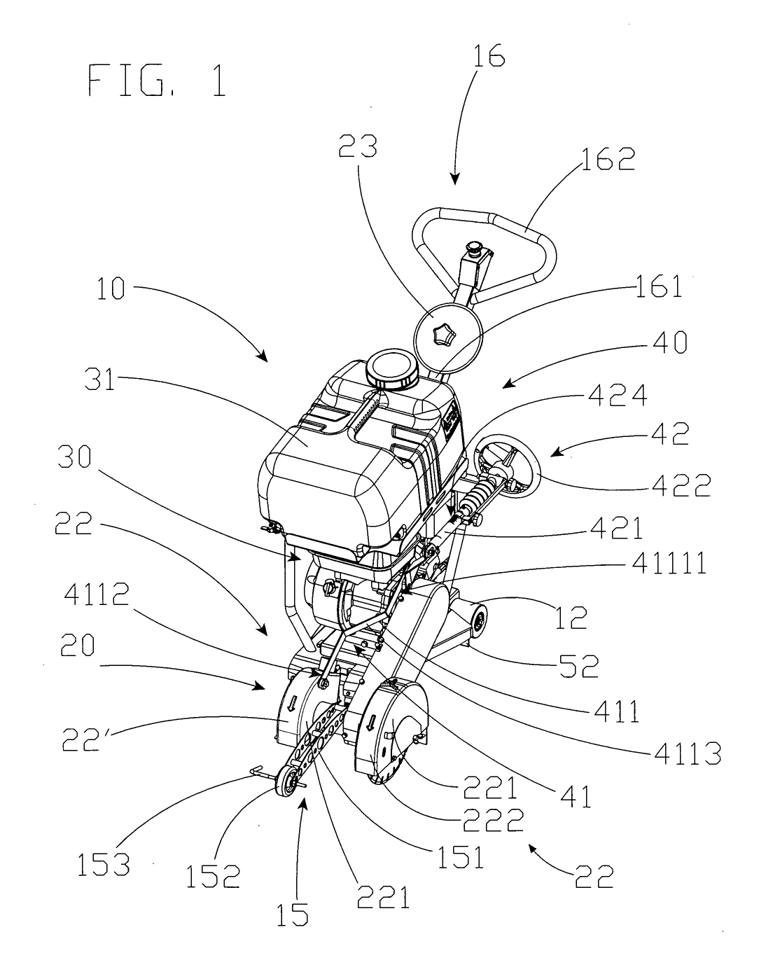

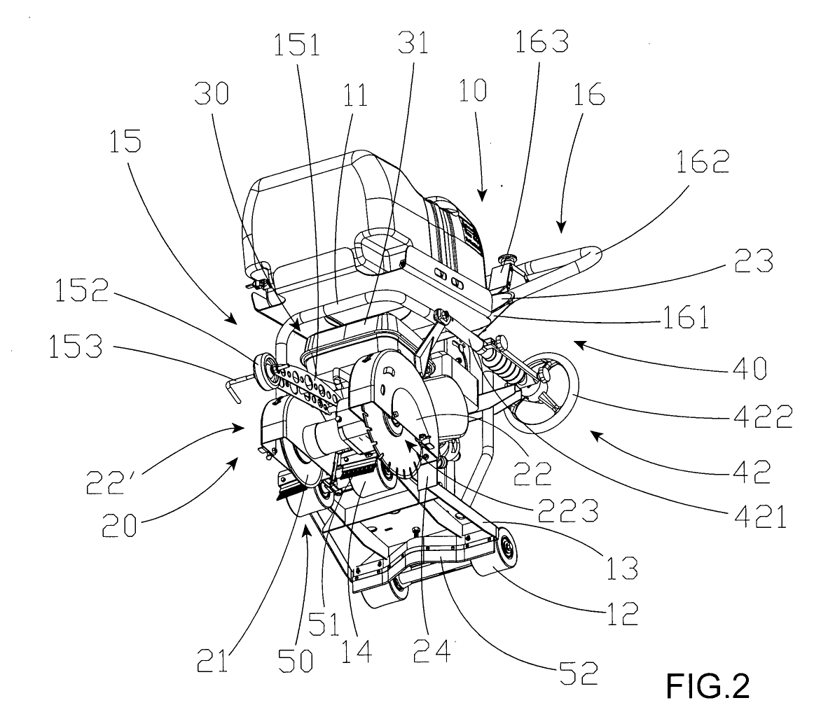

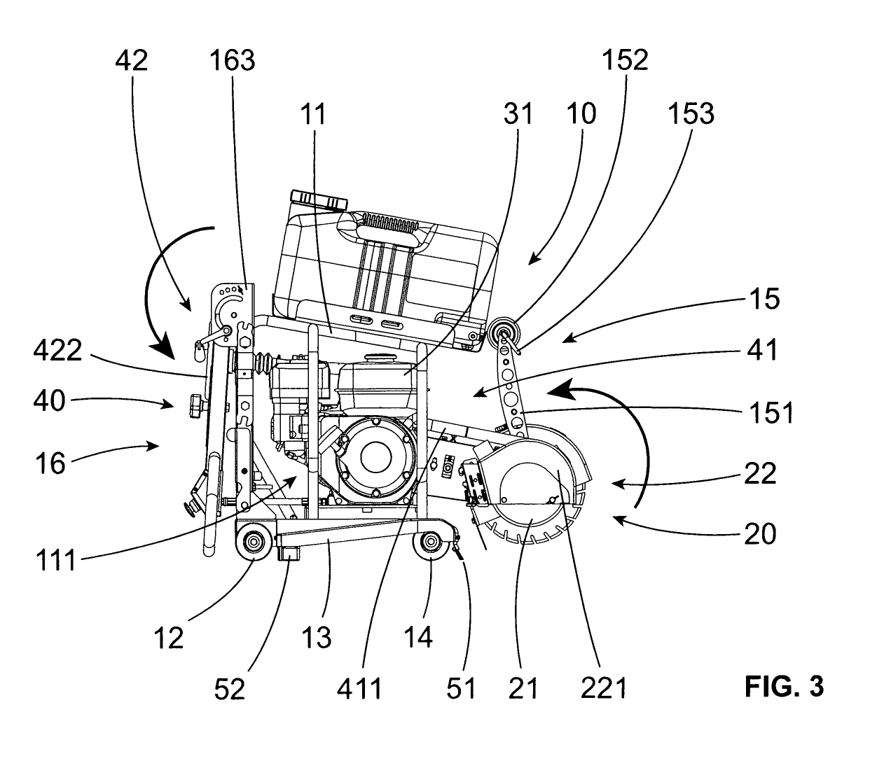

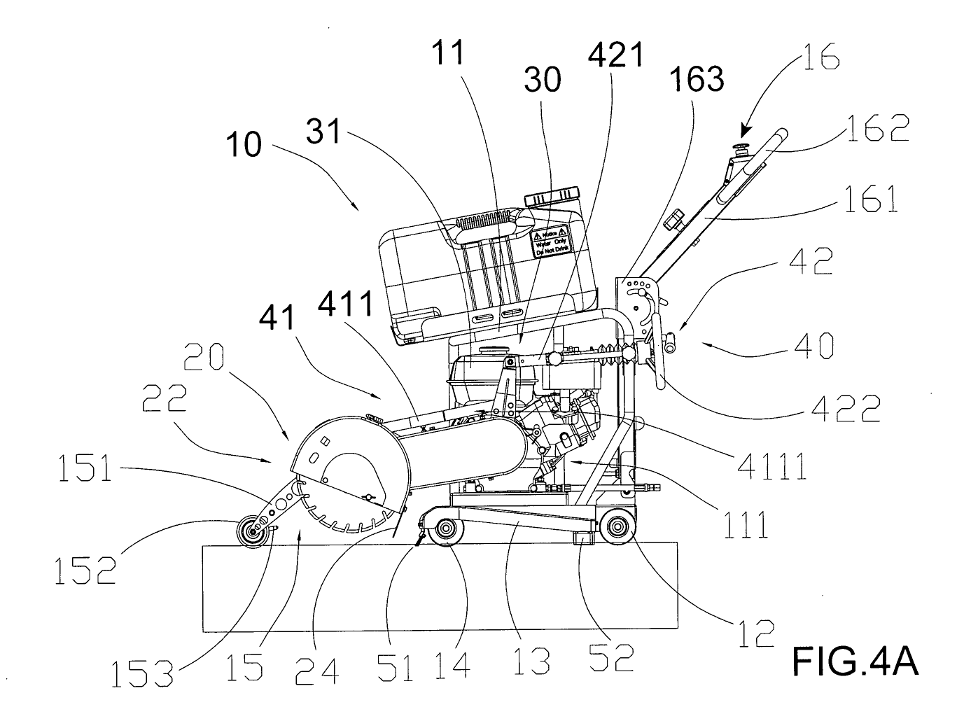

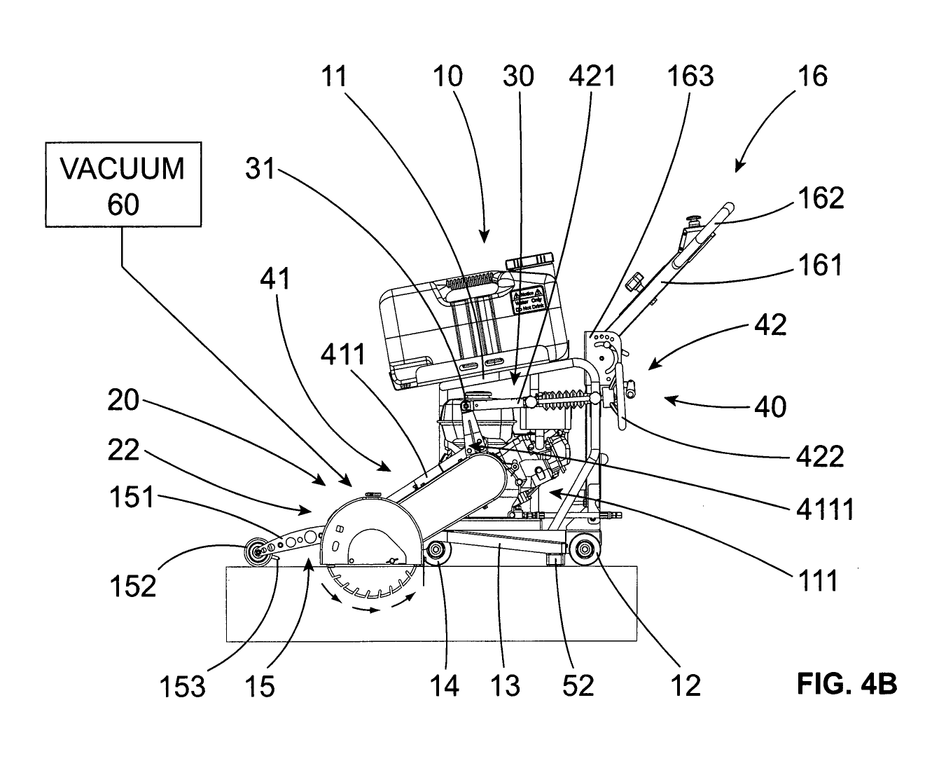

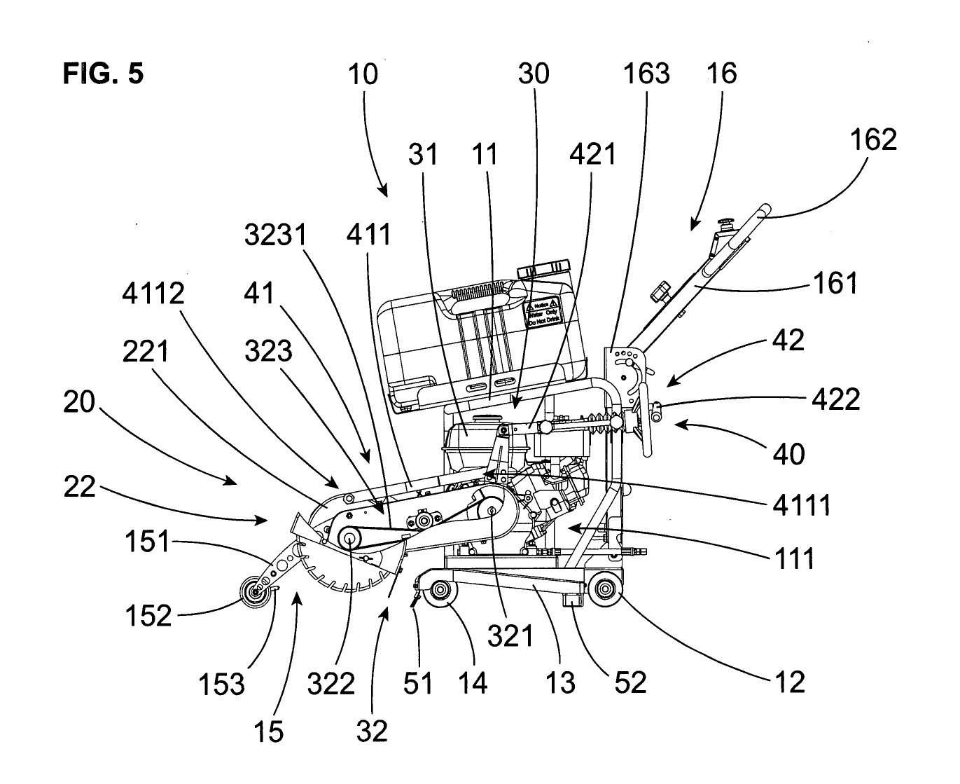

Referring to FIG. 1 to FIG. 2, FIG. 3, FIG. 4A, FIG. 4B and FIG. 5 of the drawings, a portable ground level saw machine according to a preferred embodiment of the present invention is illustrated. The ground level saw machine is for cutting an object, such as concrete, at ground level along a predetermined path, and comprises a supporting frame 10, a cutting blade 20, a power device 30, and a power cutting arrangement 40.

The supporting frame 10 comprises a main frame 11 and at least a pair of spaced apart rear wheels 12 operatively provided on a rear side of the main frame 11. On the other hand, the cutting blade 20 is provided at a lower front side of the supporting frame 10 for cutting the object at the ground level.

The power device 30 stationarily supported by the supporting frame 10 for driving the cutting blade 20 to rotate, and when the cutting blade 20 is driven to rotate, it is adapted to cut the a predetermined object at ground level.

The power cutting arrangement 40 comprises a blade supporting frame 41 and an actuating unit 42. The blade supporting frame 41 is movably extended from the main frame 11 to suspendedly and adjustably support the cutting blade 20 in a substantially horizontal orientation.

The actuating unit 42 is operatively supported by the main frame 11 to connect with the blade supporting frame 41, wherein the actuating unit 42 is adapted to manually actuated to drive the blade supporting frame 41 to adjust an elevation of the cutting blade 20 in responsive to ground level, so that when the cutting blade 20 is driven to rotate by the power device 30, the cutting blade 20 is arranged to cut the object at the ground level along a predetermined path without requiring a user to pivotally lift up the main frame 11. In other words, when the cutting blade 20 is driven to rotate by the power device 30, the actuating unit 42 is actuated to selectively adjust lower the cutting blade 20 for ground-cutting along the cutting path without requiring the main frame 11 being pivotally lifted up. The would ensure easy and relatively flexible movement of the main frame 11 so that the user is able to conveniently control the movement of the portable ground level saw machine for cutting the object along a predetermined path. Moreover, since the user does not need to physically lift up the main frame 11 for cutting, the cutting process would have enhanced stability and therefore enhanced the cutting performance of the present invention.

According to the preferred embodiment of the present invention, the supporting frame 10 further comprise a base frame 13 and a plurality of front wheels 14 mounted at a front side of the base frame 13. The main frame 11 is upwardly extended from the base frame 13 to define a storage cavity 111 within the base frame 13, wherein the power device 30 is supported within the storage cavity 111, while the blade supporting frame 41 of the power cutting arrangement 40 is extended from the storage cavity 111 to adjustably connect with the cutting blade 20. As shown in FIG. 2, FIG. 3, FIG. 4A and FIG. 4B of the drawings, the rear wheels 12 and the front wheels 14 are rotatably mounted at the rear and front portions of the base frame 13 respectively for rotatably supporting other components and allowing the saw machine (i.e. the cutting blade 20) to move during a typical cutting operation performed by the present invention.

The supporting frame 10 further comprises a pusher frame 16 movably and upwardly extended from the main frame 11 wherein a user is able to grab on the pusher frame 16 for controlling a forward or backward movement of the entire saw machine. More specifically, the pusher frame 16 comprises a connecting stem 161 upwardly and inclinedly extended from the main frame 11, and a pusher handle 162 formed at a top end portion of the connecting stem 161 for allowing the user to get hold of it for controlling the direction and movement of the saw machine. It is important to mention that the pusher frame 16 is arranged to be foldable toward the main frame 10 so that when the saw machine is not in use, the supporting frame 10 is allowed to be folded into a compact size for easy storage and transportation. More specifically, the pusher frame 16 comprises a pivotal unit 163 pivotally connecting the main frame 11 with a lower portion of the connecting stem 161 so that the connecting stem 161 and the pusher handle 162 is adapted to be rearwardly folded at 180 degrees towards the main frame 11 so as to reduce an overall height of the pusher frame 16 for reducing the supporting frame into a compact structure.

The cutting blade 20 comprises a blade member 21 and a blade guard 22 supported by the blade supporting frame 41 of the power cutting arrangement 40. The blade guard 22 has two semi-circular circular guard walls 221 and a sidewall 222 integrally and peripherally extended between a curved portion of the guard walls 221 to define a protection cavity 223 between the two guard walls 221 and the sidewall 222, wherein the blade member 21, having a diameter larger than a diameter of the circular guard walls 221, is partially and rotatably received in the protection cavity 223 so that a substantial portion of the blade member 21 is received in the protection cavity 223 for avoiding unnecessary exposure of the blade member 21 to an exterior of the portable ground level power saw machine. It is worth mentioning that the blade guard 22 is always leveled with the ground surface at all positions of the blade member 21, and that the blade member 21 is supported between the front wheels 14 at a position along a centerline of the main frame 10 for facilitating an alignment of the blade member 21 along the cutting path.

The cutting blade 20 further comprises a dust deflector 24 provided at a rear side of the blade guard 22 at a position behind the blade member 21 for deflecting dust out of the cut. Accordingly, the dust deflector 24 is embodied as a thin spring loaded fin downwardly extended from the sidewall 22 of the blade guard 22 at a position behind the blade member 21.

The cutting blade 20 further comprises an additional spare blade 23 mounted on the pusher frame 16 for allowing the user to conveniently and rapidly replace the blade member 21 with the additional spare blade 23 whenever necessary, such as a change in the nature of the object or cutting circumstances. The pusher frame 16 is also provided with an emergency stop button for allowing the user to conveniently stop the saw machine in emergency situation. Thus, the additional spare blade 23 allows a user to conveniently and rapidly replace the blade member 21 with the additional spare blade 23 whenever necessary.

The supporting frame 10 further comprises an auxiliary frame 15 extended from the main frame 11 and rotatably supported by the blade guard 22 in such a manner that the auxiliary frame 15 is capable of pivotally folding toward the main frame 11 and unfolding for extending at a front side of the cutting blade 20. More specifically, the auxiliary frame 15 comprises an elongated frame body 151 pivotally extended from the main frame 11 and an auxiliary wheel 152 rotatably mounted at a front tip portion of the frame body 151 for rotatably supporting the cutting blade 20 during a typical cutting operation. The auxiliary frame 15 can be pivotally folded toward the main frame 11 when the saw machine is not in use, as shown in FIG. 3. Therefore, the auxiliary frame 15 is foldable to reduce the overall size of the portable ground level saw machine to its minimum. As such, when the saw machine is not in use, the user may conveniently store it in a compact space, and when the saw machine is used for cutting purpose, the auxiliary frame 15 can be extended to support the cutting blade 20 and perform a proper cutting operation.

Furthermore, the auxiliary frame 15 further comprises a cutting pointer 153 rearwardly provided at the auxiliary wheel 152 and extended to align with the blade member 21 of the cutting blade 20 for indicating a cutting position of the blade member 21. Accordingly, the cutting pointer 153 has a L-shape coaxially extended from the auxiliary wheel 152 and has a pointing tip bent rearwardly to align with the blade member 21. At the cutting position, the cutting pointer 153 is moved downwardly to point at the ground surface such that when the user pulls the supporting frame 10 from behind, the user is able to obverse the cutting position of the blade member 21 to align with the cutting path.

According to the preferred embodiment, the cutting blade 20 further comprises an additional blade guard 22′ supported by the blade supporting frame 41 of the power cutting arrangement 40. The additional blade guard 22′ is fixedly supported by the supporting frame 41 of the power cutting arrangement at a position sidewardly spaced apart from the blade guard 22. The blade guard 22′ is embodied as identical and symmetrical to the blade guard 22, except their connection with the supporting frame 41. However, these additional blade guard 22′ is also always leveled with the ground surface at all positions of the blade member 21, and that the blade member 21 is supported in front of the front wheels 14, wherein the auxiliary frame 15 is frontwardly extended from the two blade members 21 (21′).

It is worth mentioning that the blade guard 22 and the additional blade guard 22′ are embodied as left and right blade guard that the auxiliary frame 15 is positioned between the blade guard 22 and the addition blade guard 22′. Therefore, the blade member 21 can be selectively coupled at one of the blade guard 22 and the additional blade guard 22′ for cutting operation. In other words, the blade member 21 can be positioned either the left side or the right side of the auxiliary frame 15. It is appreciated that two blade members 21 can be coupled with the blade guard 22 and the additional blade guard 22′ at the same time for cutting operation.

It is important to mention that when the blade member 21 is coupled at the additional blade guard 22′, it is allowed for the user to flexibly cut an object at ground level which is positioned near a vertical wall surface, since if the object is located near a vertical wall surface, the inherent size of the supporting frame 10 prohibits the blade member 21 from reaching that particular location.

The power device 30 comprises a driving motor 31 securely supported in the main frame 11, and a driving assembly 32 mechanically connecting the driving motor 31 with the cutting blade 20 for driving the blade member 21 of the cutting blade 20 to rotate at a fast speed for cutting object at ground level. More specifically, the driving assembly 32 comprises at least a driven shaft 321 extended from the driving motor 31, a driving shaft 322 coaxially extended from the blade member 21 of the cutting blade 20, and a transmission assembly 323 comprising at least a transmission belt 3231 mechanically connecting the driven shaft 321 with the driving shaft 322 for transmission the rotational movement originated from the driving motor 31 to the driving shaft 322 so as to drive the blade member 21 of the cutting blade 20 to rotate at the predetermined fast speed. In order to protect the moving parts of the power device 30, it further comprises a protective cover 33 shaped and crafted to fittedly receive the driving assembly 32 so as to physically isolate the driving assembly 32 from directly exposing to an exterior of the power device 30.

The blade supporting frame 41 of the power cutting arrangement 40 comprises a frame member 411 extended from the actuating unit 42 to the blade guard 22 of the cutting blade 20 to adjust an elevation and position of the blade member 21. More specifically, the frame member 411 is elongated in shape and has a control end portion 4111 operatively connected with the actuating unit 42, and an adjustment end portion 4112 connected with the blade guard 22 in such a manner that when the control end portion 4111 of the frame member 411 is driven to move by a horizontal driving force, the adjustment end portion 4112 of the frame member 411 is also driven to pivotally move in a vertical direction for altering the height of the blade guard 22 and the blade member 21. As such, the blade member 21 can be optimally adjusted to cut object at a predetermined or desirable elevation. Referring to FIG. 1 of the drawings, the frame member 411 is inclinedly extended in the main frame 11 along a transverse direction of the saw machine so as to accommodate the differing width of the power device 30 and the blade guard 22 of the cutting blade 20. In particular, the frame member 411 has a plurality of inclined sections 4113 formed between the control end portion 4111 and the adjustment end portion 4112 so as to form the inclined extension between the power device 30 and the cutting blade 20. Each of the inclined sections 4113 forms an angle of inclination to at least one adjacent inclined sections 4113 in order to form an overall inclination between the power device 30 and the cutting blade 20.

The actuating unit 42 comprises a driven member 421 connected to the control end portion 4111 of the frame member 411 in a longitudinally movable manner and a driving handle assembly 422 connected to the driven member 421 in the main frame 11, in such a manner that when the diving handle assembly 422 is driven to rotate, the driven member 421 is arranged to move horizontally so as to horizontally push the control end portion 4111 of the frame member 411 to move in a corresponding direction for selectively and pivotally uplifting or lowering the cutting blade 20. In other words, the elevation of the cutting blade 20 is no longer controlled by the user uplifting the entire saw machine, but by controlling the driving handle assembly 422 of the actuating unit 42. The user no longer needs to uplift the entire saw machine in order to alter the elevation of the cutting blade 20. An important feature of the present invention is that the blade guard 22 and the blade member 21 are always kept to be substantially horizontal by the frame member 41 so that the cutting performance of the saw machine of the present invention can be maintained to its maximum.

In order to control the depth of cutting, the actuating unit 42 has a cutting depth gauge 424 formed on the actuating unit 42 so as to indicate the depth of the blade member 21 of the cutting blade 20. The user needs only to look at the cutting depth gauge 424 to determine the present cutting depth of the blade member 21.

The ground level portable saw machine further comprises a dust guarding arrangement 50 provided on the supporting frame 10 for preventing cutting residues or dirt from interfering with the operation of the front wheels 14 and the rear wheels 12. The dust guarding arrangement 50 comprises a plurality of brushes 51 provided on the base frame 13 at a position in front of the front wheels 14 respectively for blocking unwanted materials from reaching the front wheels 14, and a dirt barrier 52 formed on the rear bottom portion of the base frame 13 for preventing dusts or cutting residuals from reaching the rear wheels 12.

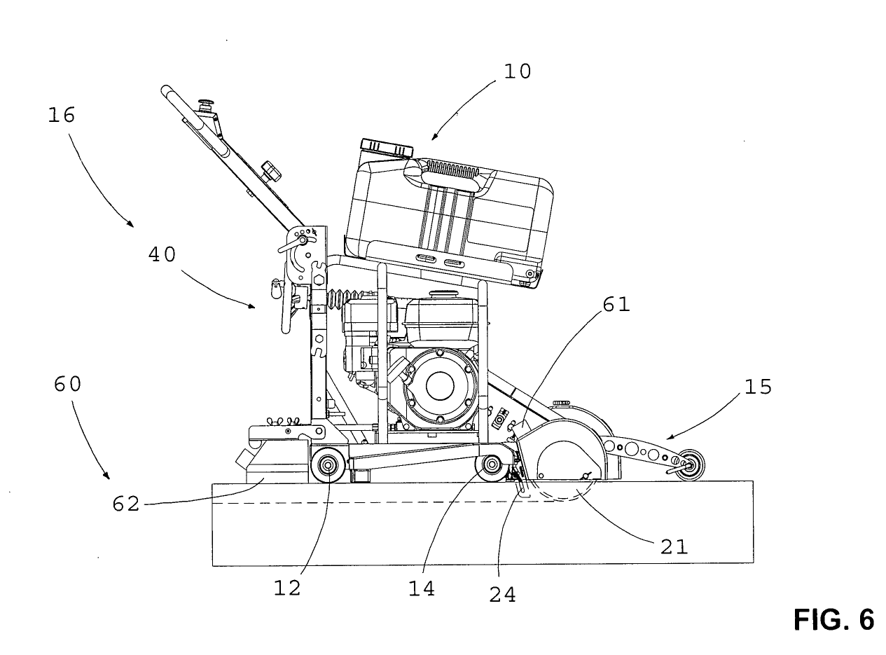

Finally, it is worth mentioning that the ground level portable saw machine may further comprise a vacuum arrangement 60 provided on the cutting blade 20 for removing dirt or cutting residuals resulting from the cutting operation, as shown in FIG. 6. The vacuum arrangement 60 comprises a vacuum pump mounted in the supporting frame 10, and a vacuuming tube defining a vacuuming channel extended to the blade guard 22 of the cutting blade 20. Accordingly, the blade guard 22 further has a vacuum opening formed on the side wall 222 for communicating with the vacuuming channel. When the saw machine is operating, cutting residuals or dirt is vacuumed by the vacuum pump through the vacuuming channel. It is important to stress that in order for the vacuuming process to be carried out effectively, the blade member 21 is preferably adjusted to rotate in a clockwise direction do that the dirt or cutting residuals are, due inertia of the cutting operation, brought to the vicinity of the vacuum opening.

As shown in FIG. 6, the vacuum arrangement 60 comprises a front vacuum unit 61 coupled at the blade guard 22 (and/or the additional blade guard 22′) for collecting the cutting residuals from the blade member 21, and a rear vacuum unit 62 supported by the supporting frame 10 at a position behind the rear wheels 12 for dust collection. It is worth mentioning that the front vacuum unit 61 can be integrated with the blade guard 22 to form a one piece integrated unit. The rear vacuum unit 62 has a width corresponding to the width of the supporting frame 10 that the width of the vacuuming opening of the rear vacuum unit 62, which is facing toward the rear wheels 12, is at least the same as the distance between the rear wheels 12. It is worth mentioning that the front and rear vacuum units 61, 62 can be embodied as front and rear vacuum openings operatively connected to a main vacuum chamber for collecting cutting residuals and dust from the openings by means of suction effect.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A portable saw machine for ground-cutting along a predetermined cutting path, comprising:
a supporting frame which comprises a main frame, at least a pair of spaced apart rear wheels operatively provided at a rear side of said main frame, and a pair of spaced apart front wheels operatively provided at a front side of said main frame;
a cutting blade comprising a blade member provided at a lower front side of said supporting frame;
a power device stationary supported at said main frame of said supporting frame for driving said cutting blade to rotate; and
a power cutting arrangement, which comprises:
a blade supporting frame movably extended from said main frame in a and suspending manner, wherein said cutting blade is suspendedly and adjustably supported by said blade supporting frame; and
an actuating unit operatively supported by said main frame to connect with said blade supporting frame, wherein said actuating unit is adapted to manually actuate to drive said blade supporting frame to adjust an elevation of said cutting blade in responsive to a ground level, so that when said cutting blade is driven to rotate by said power device, said actuating unit is actuated to selectively adjust lower said cutting blade for ground-cutting along said cutting path without requiring said main frame being pivotally lifted up.

2. The portable saw machine, as recited in claim 1, wherein said blade supporting frame of said power cutting arrangement comprises a frame member extended from said actuating unit to said cutting blade to adjust an elevation and position of said blade member, wherein said frame member is elongated in shape and has a control end portion operatively connected with said actuating unit, and an adjustment end portion connected with said cutting blade in such a manner that when said control end portion is driven to move by a horizontal driving force, said adjustment end portion of said frame member is driven to pivotally move said blade supporting frame so as to alter a height of said blade member while said blade member are kept in a substantially horizontal orientation.

3. The portable saw machine, as recited in claim 2, wherein said actuating unit comprises a driven member connected to said control end portion of said frame member in a longitudinally movable manner, and a driving handle assembly connected to said driven member in said supporting frame, in such a manner that when said diving handle assembly is driven to rotate, said driven member is arranged to move longitudinally so as to longitudinally push said control end portion of said frame member to move in a corresponding direction for pivotally and selectively uplifting and lowering said blade member of said cutting blade.

4. The portable saw machine, as recited in claim 3, wherein said actuating unit has a cutting depth gauge formed on said driving handle assembly so as to indicate a depth of said blade member of said cutting blade.

5. The portable saw machine, as recited in claim 3, wherein said supporting frame further comprises a pusher frame movably and upwardly extended from said main frame, wherein said pusher frame comprises a connecting stem upwardly, inclinedly and foldably extended from said main frame, and a pusher handle formed at a top end portion of said connecting stem such that a user is able to initiate a forwardly movement of said portable saw machine by controlling said pusher handle.

6. The portable saw machine, as recited in claim 4, wherein said supporting frame further comprises a pusher frame movably and upwardly extended from said main frame, wherein said pusher frame comprises a connecting stem upwardly, inclinedly and foldably extended from said main frame, and a pusher handle formed at a top end portion of said connecting stem such that a user is able to initiate a forwardly movement of said portable saw machine by controlling said pusher handle.

7. The portable saw machine, as recited in claim 5, wherein said pusher frame further comprises a pivotal unit pivotally connecting said main frame with a lower portion of said connecting stem so that said connecting stem and said pusher handle is adapted to be rearwardly folded at 180 degrees towards said main frame for reducing said supporting frame into a compact structure.

8. The portable saw machine, as recited in claim 6, wherein said pusher frame further comprises a pivotal unit pivotally connecting said main frame with a lower portion of said connecting stem so that said connecting stem and said pusher handle is adapted to be rearwardly folded at 180 degrees towards said main frame for reducing said supporting frame into a compact structure.

9. The portable saw machine, as recited in claim 7, wherein said cutting blade further comprises an additional spare blade mounted on said pusher frame for allowing a user to conveniently and rapidly replace said blade member with said additional spare blade whenever necessary.

10. The portable saw machine, as recited in claim 8, wherein said cutting blade further comprises an additional spare blade mounted on said pusher frame for allowing a user to conveniently and rapidly replace said blade member with said additional spare blade whenever necessary.

11. The portable saw machine, as recited in claim 8, wherein said supporting frame further comprises an auxiliary frame extended from said main frame and rotatably supported by said blade guard in such a manner that said auxiliary frame is capable of pivotally folding toward said main frame and unfolding for extending at a front side of the cutting blade to provide auxiliary support to said cutting blade.

12. The portable saw machine, as recited in claim 10, wherein said supporting frame further comprises an auxiliary frame extended from said main frame and rotatably supported by said blade guard in such a manner that said auxiliary frame is capable of pivotally folding toward said main frame and unfolding for extending at a front side of the cutting blade to provide auxiliary support to said cutting blade.

13. The portable saw machine, as recited in claim 11, wherein said auxiliary frame comprises an elongated frame body pivotally extended from said main frame and an auxiliary wheel rotatably mounted at a front tip portion of said frame body for rotatably supporting said cutting blade during a typical cutting operation.

14. The portable saw machine, as recited in claim 12, wherein said auxiliary frame comprises an elongated frame body pivotally extended from said main frame and an auxiliary wheel rotatably mounted at a front tip portion of said frame body for rotatably supporting said cutting blade during a typical cutting operation.

15. The portable saw machine, as recited in claim 13, wherein said auxiliary frame further comprises a cutting pointer rearwardly provided at said auxiliary wheel and extended to align with said blade member of said cutting blade for indicating a cutting position of said blade member.

16. The portable saw machine, as recited in claim 14, wherein said auxiliary frame further comprises a cutting pointer rearwardly provided at said auxiliary wheel and extended to align with said blade member of said cutting blade for indicating a cutting position of said blade member.

17. The portable saw machine, as recited in claim 8, wherein said cutting blade further comprises a blade guard horizontally supported by said blade supporting frame of said power cutting arrangement, wherein said blade member, having a diameter larger than a diameter of said blade guard, is partially and rotatably received in a protection cavity of said blade guard so that a substantial portion of said blade member is received in said blade guard for avoiding unnecessary exposure of said blade member to an exterior of said portable saw machine.

18. The portable saw machine, as recited in claim 12, wherein said cutting blade further comprises a blade guard horizontally supported by said blade supporting frame of said power cutting arrangement, wherein said blade member, having a diameter larger than a diameter of said blade guard, is partially and rotatably received in a protection cavity of said blade guard so that a substantial portion of said blade member is received in said blade guard for avoiding unnecessary exposure of said blade member to an exterior of said portable saw machine.

19. The portable saw machine, as recited in claim 8, further comprising a dust guarding arrangement provided on said supporting frame for preventing cutting residues and dirt from interfering with an operation of said front wheels and said rear wheels, wherein said dust guarding arrangement comprises a plurality of brushes provided on said supporting frame at a position in front of said front wheels respectively for blocking said cutting residuals and said dirt from reaching said front wheels, and a dirt barrier supported by said supporting frame at a position in front of said rear wheels for preventing said cutting residuals and said dirt from reaching said rear wheels.

20. The portable saw machine, as recited in claim 16, further comprising a dust guarding arrangement provided on said supporting frame for preventing cutting residues and dirt from interfering with an operation of said front wheels and said rear wheels, wherein said dust guarding arrangement comprises a plurality of brushes provided on said supporting frame at a position in front of said front wheels respectively for blocking said cutting residuals and said dirt from reaching said front wheels, and a dirt barrier supported by said supporting frame at a position in front of said rear wheels for preventing said cutting residuals and said dirt from reaching said rear wheels.

21. The portable saw machine, as recited in claim 18, further comprising a dust guarding arrangement provided on said supporting frame for preventing cutting residues and dirt from interfering with an operation of said front wheels and said rear wheels, wherein said dust guarding arrangement comprises a plurality of brushes provided on said supporting frame at a position in front of said front wheels respectively for blocking said cutting residuals and said dirt from reaching said front wheels, and a dirt barrier supported by said supporting frame at a position in front of said rear wheels for preventing said cutting residuals and said dirt from reaching said rear wheels.

22. The portable saw machine, as recited in claim 1, wherein said blade member is supported between said front wheels at a position along a centerline of said main frame for facilitating an alignment of said blade member along said cutting path.

23. The portable saw machine, as recited in claim 16, wherein said blade member is supported between said front wheels at a position along a centerline of said main frame for facilitating an alignment of said blade member along said cutting path.

24. The portable saw machine, as recited in claim 21, wherein said blade member is supported between said front wheels at a position along a centerline of said main frame for facilitating an alignment of said blade member along said cutting path.

25. The portable saw machine, as recited in claim 18, wherein said cutting blade further comprises an additional blade guard supported by said blade supporting frame of said power cutting arrangement, wherein said additional blade guard is fixedly supported with respective to said supporting frame at a position sidewardly spaced apart from said blade guard for flexibly cutting an object at ground level which is positioned near a vertical surface.

26. The portable saw machine, as recited in claim 21, wherein said cutting blade further comprises an additional blade guard supported by said blade supporting frame of said power cutting arrangement, wherein said additional blade guard is fixedly supported with respective to said supporting frame at a position sidewardly spaced apart from said blade guard for flexibly cutting an object at ground level which is positioned near a vertical surface.

27. The portable saw machine, as recited in claim 24, wherein said cutting blade further comprises an additional blade guard supported by said blade supporting frame of said power cutting arrangement, wherein said additional blade guard is fixedly supported with respective to said supporting frame at a position sidewardly spaced apart from said blade guard for flexibly cutting an object at ground level which is positioned near a vertical surface.
